(19) United States
(12) Patent Application Publication
(10) Pub. No.: US 2025/0370318 A1
(43) Pub. Date: Dec. 4, 2025

(54) IMAGING APPARATUS, IMAGING SYSTEM, AND INPUT DEVICE

(71) Applicant: Panasonic intellectual Property Management Co., Ltd., Osaka (JP)

(72) Inventors: Takaaki YAMASAKI, Osaka (JP); Shinichi Yamamoto, Osaka (JP)

(73) Assignee: Panasonic intellectual Property Management Co., Ltd., Osaka (JP)

(21) Appl. No.: 19/300,815

(22) Filed: Aug. 15, 2025

Related U.S. Application Data
(63) Continuation of application No. PCT/JP2023/046213, filed on Dec. 22, 2023.

(30) Foreign Application Priority Data
Feb. 24, 2023 (JP) 2023-027766

(51) Int. Cl. G03B 17/56; H04N 23/62; H04N 23/63; H04N 23/66; H04N 23/69; H04N 23/695

(52) U.S. Cl. CPC G03B 17/563; H04N 23/62; H04N 23/631; H04N 23/69; H04N 23/695; G03B 2217/002; H04N 23/66

(57) ABSTRACT

An imaging apparatus for receiving an operation by a user via at least one input device, includes: a connector connectable with the input device to input a signal indicating an operation of an operation member provided in the input device; and a controller that controls execution of an assigned function for the operation member according to the input signal, the assigned function being in advance assigned to the operation of the operation member among a plurality of functions including a function for image shooting with the imaging apparatus. The connector is connectable with the input device in each of a plurality of modes each allowing the user to operate the imaging apparatus with the input device. The controller changes assignment of the plurality of functions to the operation member, according to a using mode for the input device in the plurality of modes.

### TECHNICAL FIELD

The present disclosure relates to an imaging apparatus, an input device that inputs a user operation to the imaging apparatus, and an imaging system including the imaging apparatus and the input device.

### BACKGROUND ART

JP H7-84298 A discloses a camera for achieving different functions by simultaneously operating two or more operation members in a multifunctional camera. The camera of JP H7-84298 A is configured to achieve a function related to exposure correction of flash shooting, that is, a function of dimming correction when an operation member related to a flash operation and an operation member for achieving an exposure correction function are simultaneously operated. An object of the invention of JP H7-84298 A is to provide many functions without increasing the number of operation members.

### SUMMARY

The present disclosure provides an imaging apparatus, an imaging system, and an input device that can facilitate, according to the user's preference, operating the imaging apparatus by various operation members.

An imaging apparatus according to one aspect of the present disclosure is an imaging apparatus for receiving an operation by a user via at least one input device. The imaging apparatus includes: a connector connectable with the input device to input a signal indicating an operation of an operation member provided in the input device; and a controller that controls execution of an assigned function for the operation member according to the input signal, the assigned function being in advance assigned to the operation of the operation member among a plurality of functions including a function for image shooting with the imaging apparatus. The connector is connectable with the input device in each of a plurality of modes each allowing the user to operate the imaging apparatus with the input device The controller changes assignment of the plurality of functions to the operation member, according to a using mode for the input device in the plurality of modes.

An imaging apparatus according to another aspect of the present disclosure is an imaging apparatus for receiving an operation by a user in at least one input device, the imaging apparatus includes: a connector connected to the input device to input a signal indicating an operation of an operation member provided in the input device; and a controller that controls execution of an assigned function for the operation member, according to the input signal, the assigned function being in advance assigned to the operation of the operation member among a plurality of functions including a function for image shooting with the imaging apparatus. When a first user operation is input, the controller performs a first function among the plurality of functions, the first user operation operating simultaneously two operation members including an operation member of the input device. When a second user operation is input, the controller performs a second function different from the first function among the plurality of functions, the second user operation operating the two operation members simultaneously in a way different from the first user operation.

An imaging system according to the present disclosure is an imaging system including: the at least one input device; and the imaging apparatus. At least one of the imaging apparatus or the input device comprises a memory that stores setting information indicating the assignment of the plurality of functions to the operation member.

An input device in the present disclosure is for receiving an operation by a user for an imaging apparatus, the input device includes: an operation member; a connector connectable to the imaging apparatus to output a signal indicating an operation of the operation member to the imaging apparatus; a memory that stores setting information indicating assignment of a plurality of functions in the imaging apparatus to the operation member, and a controller that sets the setting information in the imaging apparatus via the connector.

The present disclosure can provide an imaging apparatus, an imaging system, and an input device that can facilitate, according to the user's preference, operating the imaging apparatus by various operation members.

### BRIEF DESCRIPTION OF DRAWINGS

FIGS. 1A and 1B are diagrams for illustrating a camera system according to a first embodiment of the present disclosure.

FIG. 2 is a diagram illustrating the configuration of the camera system.

FIG. 3 is a diagram illustrating the back surface of the camera system.

FIG. 4A is a flowchart illustrating the operation of a digital camera in the camera system.

FIG. 4B is a flowchart illustrating function assignment setting processing in step S2 in FIG. 4A.

FIG. 4C is a flowchart illustrating function assignment setting processing subsequent to FIG. 4B.

FIG. 5 is a diagram showing an example of function assignment setting information in the double-handed operation of the camera system.

FIGS. 6A to 6D are diagrams for illustrating a crop shooting function in the camera system.

FIGS. 7A to 7C are diagrams showing a display example of function assignment setting processing in the camera system.

FIGS. 8A to 8D are diagrams showing another display example of function assignment setting processing in the camera system.

FIG. 9 is a diagram illustrating a screen for storage/reading of grip settings in the camera system.

FIG. 10 is a diagram illustrating a data structure of setting information stored in the grip device in the camera system.

FIG. 11 is a diagram for illustrating a modification of the camera system.

FIG. 12 is a flowchart illustrating an operation of a modification of the digital camera.

FIG. 13 is a diagram illustrating an input device according to a modification.

### DETAILED DESCRIPTION

In the following, embodiments will be described in detail with reference to the drawings as appropriate. However, a detailed description more than necessary may be omitted. For example, a detailed description of already well-known matters and an overlapping description for substantially the same configuration may be omitted. This is to avoid the unnecessary redundancy of the following description and to facilitate understanding by those skilled in the art. It should be noted that the inventor provides the accompanying drawings and the following description for a person skilled in the art to fully understand the present disclosure. Thus, the drawings and the description are not intended to limit the subject matter defined in the claims.

### First Embodiment

In a first embodiment, a camera system that can be gripped by a user with both hands will be described as an example of an imaging system according to the present disclosure.

### 1. Configuration

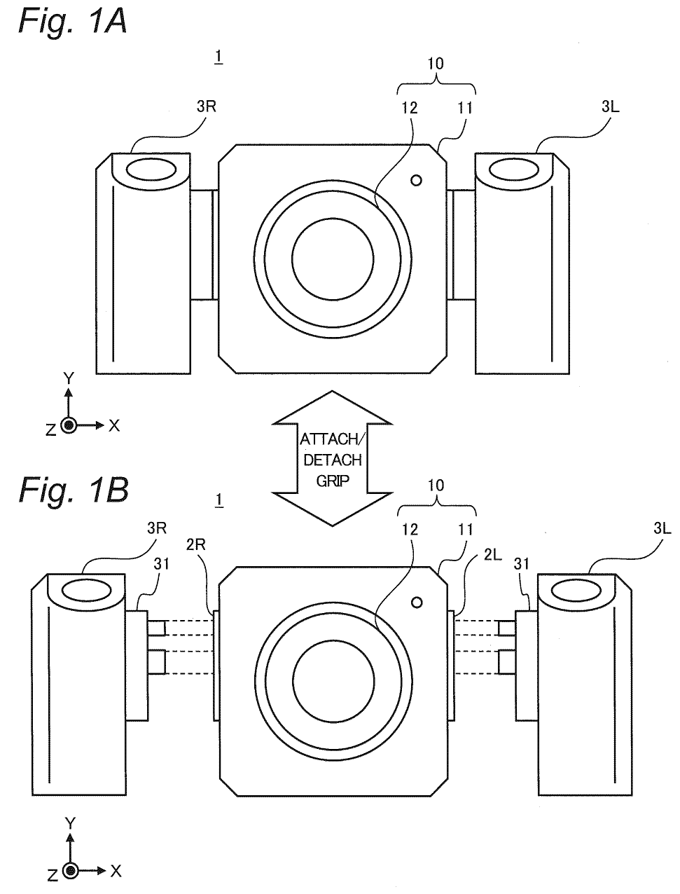

FIGS. 1A and 1B are diagrams for illustrating a camera system 1 according to the first embodiment of the present disclosure. The camera system 1 of the present embodiment includes a digital camera 10 and two grip devices 3L and 3R, for example. For example, the digital camera 10 according to the present embodiment is configured as an interchangeable lens type, and includes a camera body 11 and an interchangeable lens 12 to be detachably attached to the camera body 11. Hereinafter, the grip devices 3L and 3R may be generically referred to as “grip device 3”. The number of grip devices 3 in the present system 1 is not limited to two, and may be one or may be three or more.

FIG. 1A illustrates a state in which each grip device 3 is attached to the digital camera 10 in the present system 1. FIG. 1B illustrates a state in which each grip device 3 is detached from the digital camera 10 in the present system 1.

The digital camera 10 of the present embodiment is a box camera used by connecting various external apparatuses to a box-shaped camera body 11, for example. The outer shape of the camera body 11 is set to a shape that facilitates attaching various external apparatuses thereto and being assembled to equipment such as a camera rig. Each of the digital camera 10 and the camera body 11 is an example of an imaging apparatus in the present embodiment.

Hereinafter, an optical axis direction of the interchangeable lens 12 is defined as a Z direction, a horizontal direction orthogonal to the Z direction in the digital camera 10 is defined as an X direction, and a vertical direction orthogonal to the Z and X directions is defined as a Y direction. In the camera body 11, a +Z side surface on which the interchangeable lens 12 is attached is defined as a front surface and a −Z side opposite thereto is defined as a back surface. The +X side may be referred to as a left side, the −X side may be referred to as a right side, the +Y side may be referred to as an upward side, and the −Y side may be referred to as a downward side.

For example, as shown in FIGS. 1A and 1B, the camera body 11 of the present system 1 is configured so that two grip devices 3L and 3R can be respectively detachably attached to both the left side (+X side) and the right side (−X side). Each of the grip devices 3L and 3R is an example of an input device gripped and used by a user by the hand to operate the digital camera 10.

According to the present system 1, the user can easily grip each of the grip devices 3L and 3R on both sides of the camera body 11 with the left hand and the right hand, and can perform image shooting or the like in a stable state of holding with both hands, for example. In the present system 1, by detachably attaching each of the grip devices 3L and 3R, the user can use the digital camera 10 in various modes such as one-hand holding or assembling to a camera rig or the like without being limited to the two-hand holding described above.

### 1-1. Configuration of Digital Camera

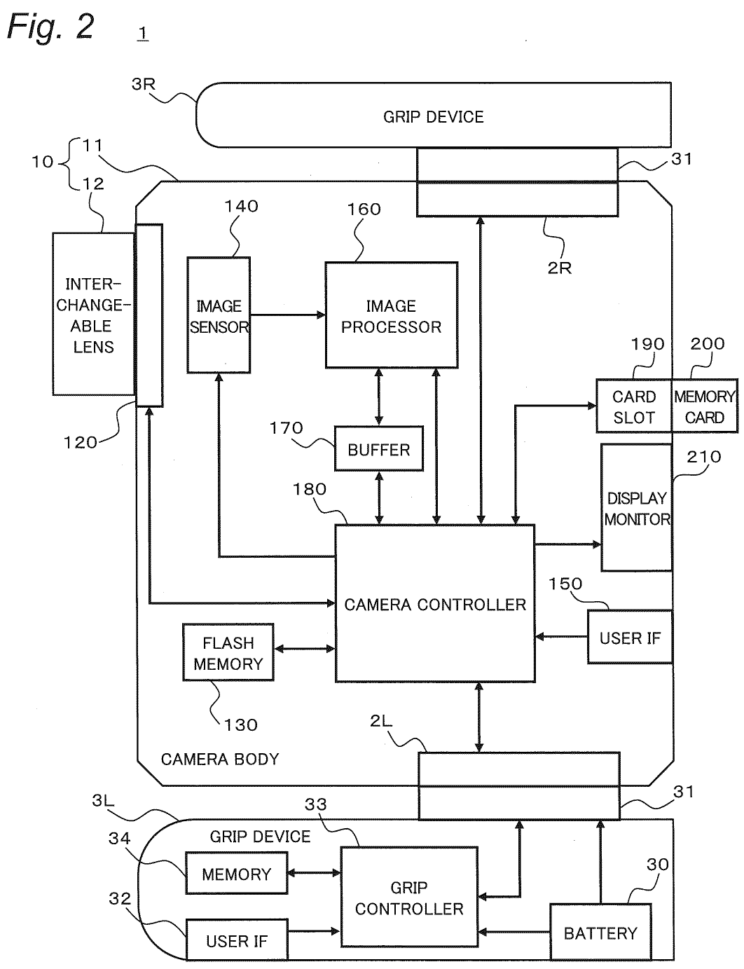

FIG. 2 is a diagram illustrating a configuration of the camera system 1 according to the present embodiment. FIG. 2 illustrates an internal configuration of a camera body 11 and one grip device 3L of the digital camera 10 in the present system 1.

In the digital camera 10 of the present embodiment, the camera body 11 includes a mount 120 for the interchangeable lens 12, an image sensor 140, a user interface 150, an image processor 160, a buffer memory 170, and a camera controller 180, for example. Furthermore, the camera body 11 includes a flash memory 130, a card slot 190, a display monitor 210, and mounts 2L and 2R to which the grip devices 3L and 3R are respectively attachable. Hereinafter, the mounts 2L and 2R in the camera body 11 may be generically referred to as “mount 2”.

The interchangeable lens 12 includes an optical system such as a zoom lens, a focus lens, and a diaphragm, a driver, and the like. The zoom lens is a lens for changing the magnification of the subject image formed by the optical system. The focus lens is a lens for changing the focus state of the subject image formed on the image sensor 140. The zoom lens and the focus lens are formed of one or more lenses.

The driver of the interchangeable lens 12 includes configurations each for driving a corresponding one unit of the optical system, such as the focus lens. For example, the driver of the focus lens includes a motor, and moves the focus lens along the optical axis of the optical system under the control of the camera controller 180. The configuration for driving each part of the optical system in the driver of the interchangeable lens 12 can be achieved by a DC motor, a stepping motor, a servo motor, an ultrasonic motor, or the like.

The mount 120 is a mount for detachably mounting the interchangeable lens 12 in the camera body 11. The mount 120 includes an interface circuit that performs various data communications between the camera body 11 and the interchangeable lens 12.

The image sensor 140 captures a subject image incident via the optical system of the interchangeable lens 12 to generate RAW data, for example. The RAW data is an example of image data in RAW format corresponding to a state of an imaging result by the image sensor 140. For example, the RAW data includes information on the light quantity exposed for each pixel in the Bayer array, and indicates an image of an imaging result. The image sensor 140 performs an imaging operation of an image constituting each frame of a moving image, for example. The image sensor 140 is an example of an imaging unit in the present embodiment.

The image sensor 140 generates RAW data of a new frame at a predetermined frame rate (e.g., 30 frames/sec). The RAW data generation timing and the electronic shutter operation in the image sensor 140 are controlled by the camera controller 180. As the image sensor 140, various image sensors such as a CMOS image sensor, a CCD image sensor, or an NMOS image sensor can be used.

The user interface 150 is a general term for operation members that receive an operation (instruction) from a user. The user interface 150 includes buttons, levers, dials, switches, and the like that receive user operations. A specific example of the user interface 150 will be described below.

The image processor 160 performs predetermined processing on the RAW data output from the image sensor 140 to generate image data of a shooting result. For example, the image processor 160 may perform processing for development and may generate an image to be displayed on the display monitor 210 or the like. Examples of the predetermined processing include debayer processing, white balance correction, gamma correction, YC conversion processing, electronic zoom processing, compression processing, expansion processing, and the like, but are not limited thereto. The image processor 160 may be configured with a hard-wired electronic circuit, or may be configured with a microcomputer, a processor, or the like using a program.

The buffer memory 170 is a recording medium that functions as a work memory for the image processor 160 and the camera controller 180. The buffer memory 170 is implemented with a dynamic random-access memory (DRAM) or the like. The flash memory 130 is a non-volatile recording medium. Each of the memories 130 and 170 is an example of a memory in the present embodiment.

The camera controller 180 controls the whole operation of the digital camera 10. The camera controller 180 uses the buffer memory 170 as a work memory during a control operation or an image processing operation.

The camera controller 180 includes a CPU or an MPU, and the CPU or MPU implements a predetermined function by executing a program (software). The camera controller 180 may include a processor including a dedicated electronic circuit designed to implement a predetermined function instead of the CPU or the like. That is, the camera controller 180 can be implemented with various processors such as a CPU, an MPU, a GPU, a DSP, an FPGA, and an ASIC. The camera controller 180 may include one or more processors.

The card slot 190 can mount the memory card 200, and accesses the memory card 200, based on the control from the camera controller 180. The digital camera 10 can record image data in the memory card 200, and read the recorded image data from the memory card 200. The card slot 190 may be provided so that a plurality of (e.g., two) memory cards 200 can be simultaneously attached. For example, the memory card 200 is an SD card, an XQD card, Cfexpress, or the like.

The display monitor 210 is an example of a display that displays various types of information (eventually, an example of an output interface). For example, the display monitor 210 displays an image (through image) indicated by image data which is captured by the image sensor 140 and on which image processing is performed by the image processor 160. The display monitor 210 displays a menu screen or the like for a user to perform various settings on the digital camera 10. The display monitor 210 can include a liquid crystal display device or an organic EL device, for example.

The mount 2 is an example of a connector to which the grip device 3 is detachably attached in the camera body 11. In the example in FIG. 1B, the mounts 2L and 2R are provided on the side surfaces on the ±X side of the camera body 11 so that the grip devices 3L and 3R can be fixed, respectively. For example, as shown in FIG. 2, the camera controller 180 inputs and outputs signals to and from the connected grip devices 3L and 3R through the respective mounts 2L and 2R.

The mount 2 includes a mechanism for mechanically fixing the grip device 3 and a connection circuit for electrically connecting the grip device 3 and the camera body 11. The digital camera 10 of the present embodiment is configured to be able to be supplied with power from the grip device 3 via the mount 2, for example. For example, the connection circuit of the mount 2 may conform to a predetermined communication standard such as USB. The mount 2 may also be connectable to an external apparatus different from the grip device 3. The digital camera 10 of the present embodiment may be supplied with power from an external power supply different from the grip device 3 by using the mount 2 or various configurations instead thereof.

The digital camera 10 of the present embodiment is not limited to the above configuration example, and may have various configurations. For example, in the digital camera 10, an external display device may be used instead of the display monitor 210 or in addition thereto. As an example of the output interface in this case, the camera body 11 of the digital camera 10 may include an interface circuit that outputs a video signal to an external electronic apparatus according to a predetermined signal standard such as HDMI or SDI.

The digital camera 10 of the present embodiment may include various interface circuits that perform wired or wireless communication with an external apparatus according to a predetermined communication standard, not limited to the communication of the video signal. For example, the predetermined communication standard includes IEEE 802.11, Wi-Fi, Bluetooth, or the like. Such an interface circuit is an example of a connector or an output interface in the digital camera 10 of the present embodiment.

### 1-2. Configuration of Grip Device

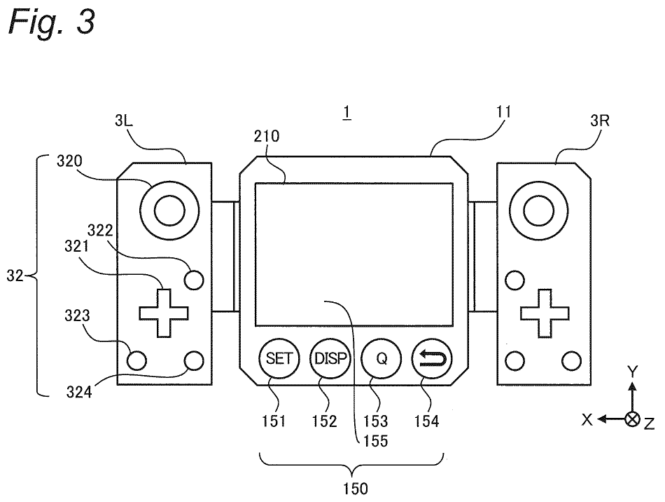

In FIG. 2, the internal configuration of one of the grip devices 3L and 3R on both sides is illustrated, but each of the grip devices 3L and 3R can adopt the same internal configuration. For example, exterior configurations of both the grip devices 3L and 3R are symmetrical (see FIGS. 1A, 1B and 3).

As shown in FIG. 2, the grip device 3 includes a mount 31, a user interface 32, a grip controller 33, and a memory 34, for example. The battery 30 can be detachably attached to the grip device 3 so as to be housed inside, for example. For example, the grip device 3 has a substantially U-shaped cross-sectional shape that is convex toward the front side (+Z side) in the XZ cross section, and has an outer shape that can be easily gripped by a user's hand (see FIGS. 1A and 1B).

The battery 30 supplies power for driving the digital camera 10 and the grip device 3. The power from the battery 30 is supplied to the digital camera 10 via the mount 31, for example. The battery 30 may be a dry battery or a rechargeable battery, for example. Instead of such a battery, power supplied from the outside by a power cord may be supplied to the digital camera 10.

The mount 31 is an example of a connector to which the grip device 3 is detachably attached to the camera body 11. For example, the mount 31 includes a mechanism (e.g., a fixing screw) mechanically engaged with mount 2 of the camera body 11, and a connection terminal (e.g., a USB terminal) electrically connected to the camera body 11. The connection terminals of the mount 31 may be shared for signal input/output and power supply or may include separate terminals.

The user interface 32 includes an operation member such as a switch and a button provided on the exterior of the grip device 3, for example. When receiving an operation by the user on the user interface 32, the grip device 3 transmits a signal corresponding to the user operation to the camera body 11 via the mount 31. Details of the user interface 32 will be described below.

For example, the grip controller 33 includes a CPU and the like, and controls the operation of the entire grip device 3. The grip controller 33 reads data, programs, and the like stored in the memory 34, and performs various arithmetic processing, to implement various functions. For example, the grip controller 33 controls data communication between the grip device 3 and the camera body 11. The grip controller 33 can be implemented by various processors similarly to the camera controller 180, not limited to the above.

The memory 34 is a recording medium that stores data, programs, and the like necessary for implementing the function of the grip controller 33, and includes a flash memory, for example. The memory 34 may include a RAM, and may temporarily store data and function as a work area of the grip controller 33.

### 1-3. User Interface

Specific examples of the user interfaces 150 and 32 of the digital camera 10 and the grip device 3 in the present system 1 will be described with reference to FIG. 3. FIG. 3 is a diagram illustrating the back surface of the camera system 1 of the present embodiment. In the example in FIG. 3, a case where the grip devices 3L and 3R are attached to both sides of the camera body 11 in the present system 1 will be illustrated.

FIG. 3 shows a joystick 320, direction keys 321, and a plurality of function buttons 322 to 324 as examples of the user interface 32 of the grip device 3. As an example of the user interface 150 of the camera body 11, a touch panel 155, a SET button 151, a DISP button 152, a Q button 153, and a return button 154 are shown. When receiving an operation by the user, each of the user interfaces 32 and 150 transmits various instruction signals to the camera controller 180.

The joystick 320 is an operation member that can be operated to tilt or push the stick member provided at the center in the upward, downward, left, and right directions and in an oblique direction therebetween. The user can select various items displayed on the display monitor 210 or move a cursor by operating the joystick 320 in any direction. According to the joystick 320, a user operation in which the degree of tilting in various directions or the degree of pushing is adjusted can be received.

The direction key 321 includes a depression-type button portion corresponding to the upward, downward, left, and right directions, and can perform an operation corresponding to a direction operation of the joystick 320. A depression-type button corresponding to a push-in operation of the joystick 320 may be provided at the center of the direction key 321.

The function buttons 322 to 324 are depression-type buttons to which various functions in the digital camera 10 can be assigned in advance. The operation member to which various functions of the digital camera 10 are assigned is not particularly limited thereto, and can be assigned also to the joystick 320 and the direction key 321, for example.

The SET button 151, the DISP button 152, the Q button 153, and the return button 154 are depression-type buttons used for the operation of the setting menu, for example. For example, each of the buttons 151 to 154 may be provided on the upward surface or the downward surface of the camera body 11, not limited to the back surface of the camera body 11. Each of the buttons 151 to 154 may function as a function button in various operation modes.

When the digital camera 10 is in the shooting mode or the playback mode, depressing the SET button 151 by the user causes the camera controller 180 to display a menu screen on the display monitor 210. The menu screen is a screen for setting various conditions for shooting/playback. When the SET button 151 (or the joystick 320) is depressed while setting items of various conditions are selected, the camera controller 180 fixes the setting of the selected item.

The touch panel 155 is arranged to be superimposed on the display screen of the display monitor 210, and detects a touch operation on the display screen by the user's finger. Accordingly, the user can perform operations such as specification of a region on the image displayed on the display monitor 210 and various selections on the menu screen. A virtual button displayed on the touch panel 155 may function as a function button.

### 2. Operation

The operation of the camera system 1 configured as described above will be described below.

The digital camera 10 of the present embodiment has a plurality of functions (hereinafter also referred to as “camera functions”) such as various shooting functions used by the user to shoot a desired image. For example, each camera function can be used by a user operating an operation member in a state of being assigned to the operation member in the grip device 3. The present system 1 provides the assignment setting of the camera functions in a flexible and changeable manner according to various modes of use of the user such as the manner of mounting various grip devices 3L and 3R on the digital camera 10. Hereinafter, details of the operation of the present system 1 will be described.

### 2-1. Overall Operation

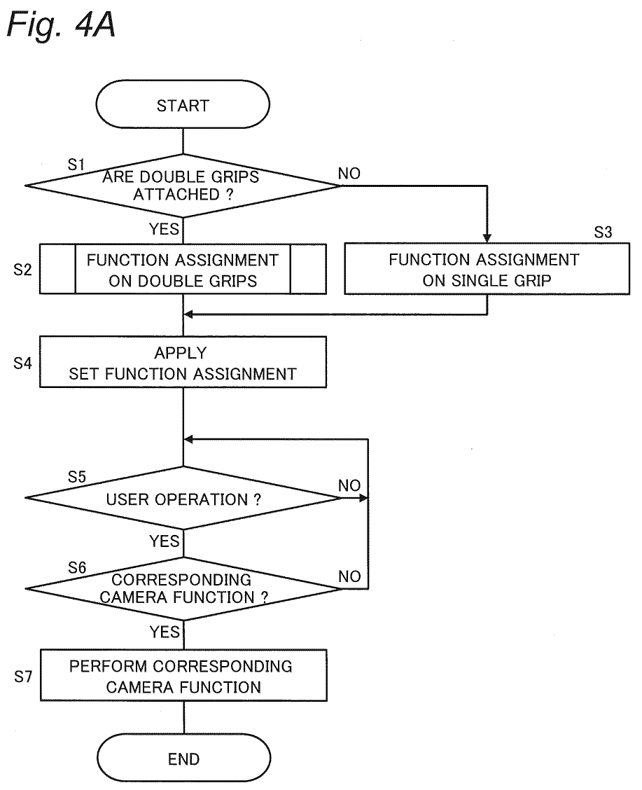

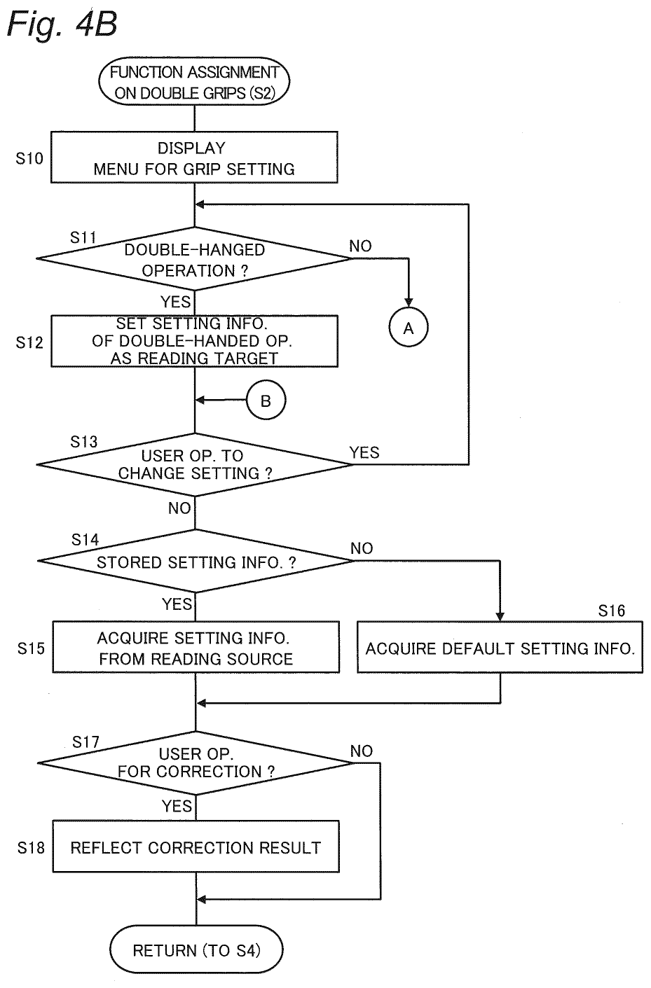

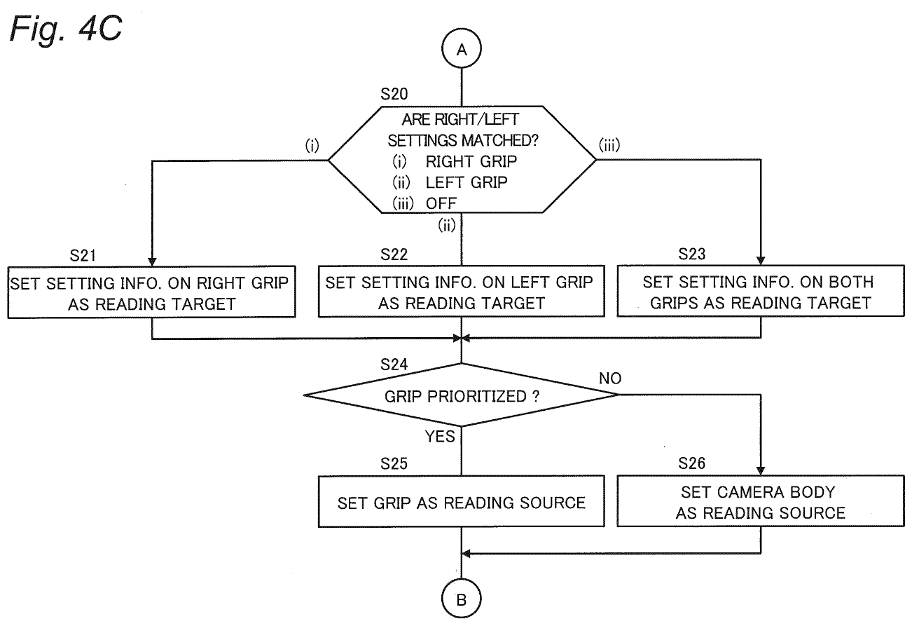

An overall operation of the digital camera 10 in the present system 1 will be described with reference to FIG. 4A.

FIG. 4A is a flowchart illustrating the operation of the digital camera 10 in the present system 1. For example, the processing of the flow illustrated in FIG. 4A starts when power is input on in a state where one or more grip devices 3 are attached to the camera body 11. Each processing of the present flow is executed by the camera controller 180 of the camera body 11 in the digital camera 10, for example.

First, the camera controller 180 detects the grip device 3 attached to the camera body 11 and determines whether the camera body 11 is in a state where the double grip devices 3L and 3R are attached to both sides or in a state where the single grip device 3 is attached to one side (S1). For example, the processing of step S1 can be performed by detecting energization in each of the mounts 2R and 2L or transmitting and receiving a signal between the camera controller 180 and the grip controller 33.

When the camera body 11 is in the state where the double grip devices 3L and 3R are attached to both sides (YES in S1), the camera controller 180 sets the assignment of camera functions for the grip devices 3L and 3R on both sides (S2). For example, with a predetermined setting screen displayed on the display monitor 210, the camera controller 180 receives user operations in the various user interfaces 150 and 32, to perform assignment setting of camera functions for the grip devices 3L and 3R on both sides (S2).

For example, the present system 1 is possible to achieve ergonomically, in a situation where the user operates the digital camera 10 using each grip device 3, function assignment to realize natural operation or function assignment that allows the user to easily come up with the corresponding camera function. For example, in the present system 1, a specific camera function is assigned to an operation of simultaneously using the grip devices 3L and 3R with both hands. According to such a double-handed operation (details will be described below), the user can intuitively operate the digital camera 10 and can suppress an erroneous operation.

In the present system 1, the camera function can be assigned also to various operations in the grip devices 3L and 3R on both sides, without being limited to the double-handed operation described above. The present system 1 can also use setting information in which function assignment is stored in advance. Details of the function assignment in step S2 will be described later (see FIGS. 4B to 4C).

On the other hand, when the camera body 11 is in the state in which the single grip device 3 is attached to one side (NO in S1), the camera controller 180 performs function assignments on various operation members in the attached grip 3 on one side (S3). For example, similarly to step S2, the camera controller 180 causes the display monitor 210 to display a setting screen, causes the various user interfaces 150 and 32 to receive various inputs by the user, and performs setting according to the user instruction (S3). In steps S2 and S3, function assignments on not only the operation member in the grip device 3 but also the operation member in the digital camera 10 may be performed.

The camera controller 180 applies the function assignment set in step S2 or S3 to the present system 1, and holds setting information indicating a setting of the function assignment in the buffer memory 170, for example (S4).

Thereafter, during various operations of the present system 1, the camera controller 180 receives user operations via various operation members in the respective user interfaces 150 and 32 in the present system 1 (S5).

When a user operation is input in various operation members (YES in S5), the camera controller 180 determines whether a camera function corresponding to the input user operation is present, based on setting information on the function assignment, for example (S6).

When the camera function corresponding to the input user operation is present (YES in S6), the camera controller 180 controls the digital camera 10 so that the digital camera 10 executes the camera function (S7).

On the other hand, when no camera function corresponding to the input user operation is present (YES in S6), the camera controller 180 returns to step S5 without executing the camera function as in step S7, for example.

For example, after execution of the camera function corresponding to the user operation (S7), the camera controller 180 ends the processing shown in the present flow. Thereafter, the camera controller 180 may perform the processing in and after step S1 again, or may omit the processing in steps S1 to S4 and perform the processing in and after step S5 again. For example, in a case of no change or the like in the attachment state of the grip device 3, steps S1 to S4 may be omitted.

According to the above processing, in the present system 1, according to the state where the various grip devices 3L and 3R are attached to the digital camera 10 (S1), the camera functions are assigned (S2, S3). Accordingly, it is possible to easily use various camera functions according to a mode in which the user uses the present system 1 with both hands or one hand.

### 2-2. Double-Handed Operation

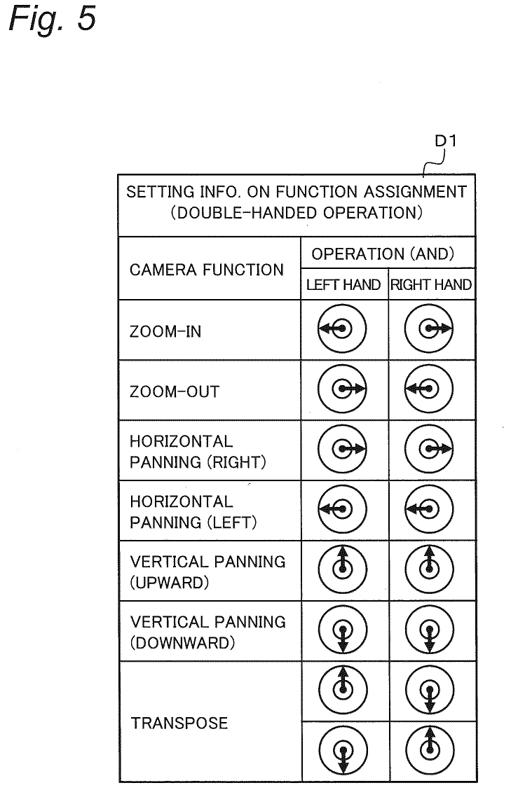

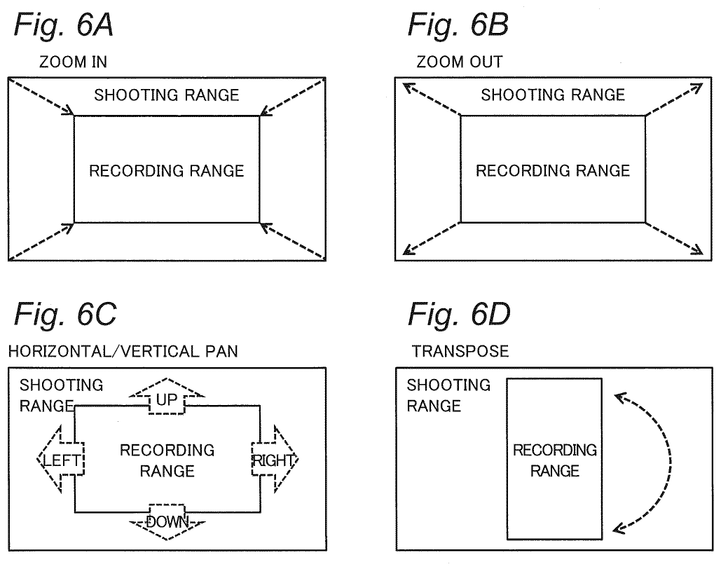

For example, when the grip devices 3L and 3R on both sides are used (YES in S1 in FIG. 4A), the user can use the camera function by double-handed operation (S5 to S7). A specific example of such a case will be described with reference to FIGS. 5 to 6D.

FIG. 5 shows an example of the function assignment setting information D1 in the double-handed operation of the present system 1. In the present example, a plurality of functions in the crop shooting of the digital camera 10 are assigned to various simultaneous operations of the joystick 320 of the left hand grip device 3L and the joystick 320 of the right hand grip device 3R (S2 in FIG. 4A).

FIGS. 6A to 6D are diagrams for illustrating a crop shooting function in the present system 1. The crop shooting is a shooting method in which a range cropped for use in recording image data of a shooting result, that is, a recording range is changed in a shooting range of the digital camera 10 such as a whole range of pixels in an imaging surface of the image sensor 140. The crop shooting is useful in a high-resolution wide-angle capturing state such as 8K.

The setting information D1 illustrated in FIG. 5 assigns an operation of tilting each of the joysticks 320 in a predetermined direction to a function of zooming in, zooming out, panning in various directions, and transposing in crop shooting (S4 in FIG. 4A).

For example, when the user tilts the left hand joystick 320 in the left direction and tilts the right hand joystick 320 in the right direction (S5), the camera controller 180 executes the zoom-in function (S7) with reference to the setting information in FIG. 5 (S6). For example, as shown in FIG. 6A, the zoom-in function of the crop shooting is performed by reducing the recording range in the shooting range.

In the present example, in contrast to the zoom-in operation described above, when the user tilts the left hand joystick 320 in the right direction and tilts the right hand joystick 320 in the left direction (S5), the camera controller 180 executes the zoom-out function (S7). For example, as shown in FIG. 6B, the zoom-out function of the crop shooting is performed by enlarging the recording range in the shooting range.

According to the function assignment of the double-handed operation as described above, the zoom-in/out function is executed according to the user's operation of widening or narrowing the interval between the right hand joystick 320 and the left hand joystick 320, and an intuitive operational feeling for the user can be achieved. Such double-handed operation is not limited to zooming in/out of the crop shooting, and instead, a function of zooming in/out of the optical zoom may be assigned.

In the examples in FIGS. 5 to 6D, when a user operation of directing the two joysticks 320 in the same direction among the upward, downward, left, and right directions is input (S5), the camera controller 180 executes the panning function along the direction in the crop shooting, for example (S7). For example, as shown in FIG. 6C, the panning function of the crop shooting is performed by moving the recording range in parallel in a specific direction in the shooting range.

According to such function assignment, in addition to allowing the user to intuitively operate the panning function, it is possible to reduce malfunctions of the panning function as compared with a case where the panning function is assigned to the user operation of directing one joystick 320 in one direction, for example. For example, even if the user performs an erroneous operation of unexpectedly tilting one joystick 320, the camera controller 180 can be prevented from executing the panning function at the time of assignment in FIG. 5 (NO in S6). That is, according to the function assignment of the double-handed operation in the present system 1, it is possible to substantially prohibit the execution of the camera function due to an erroneous operation on one side.

In the examples in FIGS. 5 to 6D, when a user operation of directing one joystick 320 in the upward direction and directing the other joystick 320 in the downward direction is input (S5), the camera controller 180 executes the transposing function (S7). For example, as shown in FIG. 6D, the transposing function in the crop shooting is performed by swapping the longitudinal direction of the recording range between the horizontal direction and the vertical direction of the shooting range. For example, a vertical image in which the longitudinal direction of the recording range is set in the vertical direction is useful for use in display on a smartphone or the like.

According to the function assignment of various simultaneous operations with both hands in the present system 1 as described above, the user can intuitively operate the digital camera 10 utilizing the state of holding with both hands, and can easily use various camera functions.

At the time of the double-handed operation as described above, the camera controller 180 may control the speed at which the corresponding camera function is implemented according to the degree of force with which the user tilts the joystick 320. For example, as the force of tilting the joystick 320 is larger, the speed of zooming, panning, or the like may be higher.

In the present system 1, the assignment between various camera functions and user operations as described above is not particularly limited to the above, and can be freely changed. For example, regarding the zoom-in/out function, in contrast to the above example, the present system 1 may assign the zoom-in function to the operation of narrowing the interval between the joysticks 320 of both hands, and assign the zoom-out function to the operation of expanding the interval.

### 2-3. Function Assignment Setting

The processing of setting the function assignment of the grip devices 3L and 3R on both sides in step S2 in FIG. 4A in the present system 1 will be described with reference to FIGS. 4B to 4C and FIGS. 7A to 8D. FIGS. 4B and 4C are flowcharts illustrating function assignment setting processing (S2 in FIG. 4A) in the present system 1.

### 2-3-1. Case of Double-Handed Operation

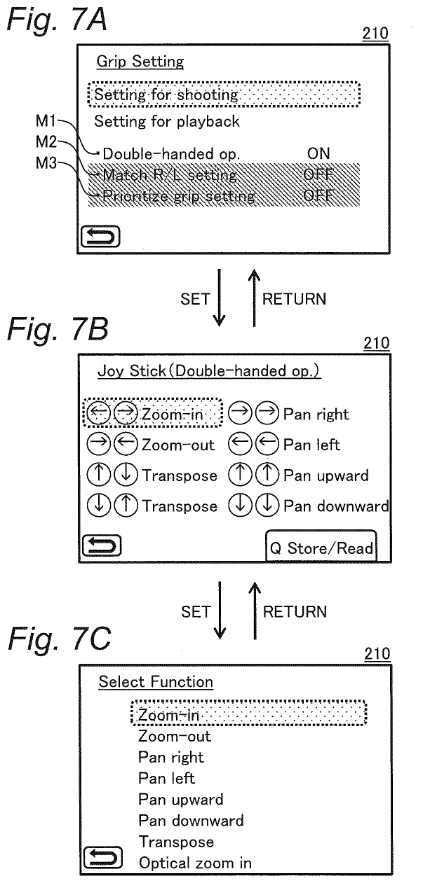

FIG. 7A illustrates a menu screen for grip settings in the digital camera 10. For example, in step S2 in FIG. 4A, the camera controller 180 first causes the display monitor 210 to display a menu screen as shown in FIG. 7A (S10).

For example, as shown in FIG. 7A, in the digital camera 10 of the present embodiment, the user can set the assignment of the camera functions separately between the case for shooting and the case for playback by selecting from options such as “setting for shooting” or “setting for playback”. In the present example, a case where the setting for shooting is selected will be described. It should be noted that in the present system 1, such assignment setting for each option is not particularly limited to the case for shooting and the case for playback, and for example, an option for shooting of the still image or a moving image may be provided.

For example, as shown in FIG. 7A, the digital camera 10 of the present embodiment displays a plurality of setting items M1 to M3 such as “double-handed operation” on the display monitor 210. In the example in FIG. 7A, the setting item M1 as to whether to enable the function assignment of the double-handed operation as described above is set to ON by the user (YES in S11). In response to this, the other setting items M2 and M3 are gray-out displayed while being set to OFF. The gray-out display indicates that the change by the user input is disabled.

For example, when the setting item M1 of the double-handed operation is ON (YES in S11), the camera controller 180 sets a target to be read from among the pre-stored pieces of setting information to the setting information of the double-handed operation (S12). For example, in the example in FIG. 7A, the camera controller 180 controls the setting items M2 and M3 to the gray-out display in OFF, and sets the reading source of the setting information of the function assignment to the camera body 11 (the memory card 200 inserted into the camera body 11).

In a state where such a menu screen for grip settings is displayed, the camera controller 180 receives various user operations through the various user interfaces 150 and 32 (S13). For example, when a user operation of changing the setting item M1 is received (YES in S13), the camera controller 180 performs the processing in and after step S11 again in the changed setting. On the other hand, when the user performs a predetermined operation such as depressing the SET button 151 instead of changing the setting items M1 to M3 (NO in S13), the camera controller 180 causes the display monitor 210 to transition to the function assignment setting screen. A function assignment screen transitioning from the state in FIG. 7A is illustrated in FIG. 7B.

For example, as illustrated in FIG. 7B, the camera controller 180 divides the items by the type of the user operation by the combination of the directions of the joysticks 320 on both sides on the display monitor 210, and displays the currently assigned camera function in each item. As the initial display in FIG. 7B, the camera controller 180 displays the function assignment according to the setting information D1 acquired in advance from the flash memory 130, the memory card 200, or the like.

Specifically, when no change in the setting items M1 to M3 by the user operation (NO in S13), the camera controller 180 determines whether setting information stored in the reading source set in step S12 or the like is present (S14). When the stored setting information is present (YES in S14), the camera controller 180 acquires the setting information of the function assignment from the reading source (S15). On the other hand, when no stored setting information (NO in S14), the camera controller 180 acquires setting information stored in advance as a default in the flash memory 130 or the like, for example (S16).

Thereafter, the camera controller 180 receives various user operations for correcting the function assignment indicated by the acquired setting information (S17). When the function assignment is corrected by the user operation (YES in S17), the camera controller 180 reflects the correction result, such as writing the corrected setting information of the function assignment in a predetermined storage destination (S18). On the other hand, when no user operation for correction in particular (NO in S17), the camera controller 180 ends the processing shown in FIG. 4B and applies the acquired setting information to the function assignment of the present system 1 (S4 in FIG. 4A).

In the processing of correcting the function assignment (S17, S18), the present system 1 receives a specification operation for specifying an item to which the user desires to change the camera function to assign, such as “zoom-in” in the example in FIG. 7B, on such a function assignment screen. For example, the specification operation is performed by the touch panel 155, the joystick 320, the direction key 321, the SET button 151, or the like.

FIG. 7C illustrates a function selection screen transitioned from the state in FIG. 7B. For example, as shown in FIG. 7C, the camera controller 180 causes (the user operation of) the specified item to display a list of assignable camera functions, and receives a selection operation in which the user selects a desired camera function from among the list. For example, the selection operation is performed by the touch panel 155, the joystick 320, the direction key 321, the SET button 151, or the like.

The screen transition in FIGS. 7A to 7C can be reversed by performing a return operation by the user, for example. For example, the return operation is performed by the depression operation, the touch operation, or the like on the return button 154. For example, when the return operation is input on the grip setting screen as shown in FIG. 7A, the camera controller 180 ends the processing shown in FIG. 4B, and applies the setting information D1 corresponding to the function assignment screen immediately before the return operation to the function assignment of the present system 1 as the processing result of step S2 in FIG. 4A (S4).

In the above description, an example of the function assignment to the double-handed operation in which the joysticks 320 on both sides are tilted in the vertical and horizontal directions has been described, but the present system 1 is not particularly limited thereto. For example, the present system 1 may receive the assignment of camera functions similarly to the above description also for an operation of tilting the joystick 320 in various oblique directions. For example, 64 types of camera functions can be assigned to double-handed operation of operation of tilting an individual joystick 320 in 8 types of directions. In the present system 1, the operation of the center push of the joystick 320 may also be a target of function assignment.

For example, in the present system 1, the target of the double-handed operation is not limited to the joystick 320 and may be various operation members in the user interface 32 of the grip device 3 (or the user interface 150 of the digital camera 10). For example, the camera function may be assigned also to the simultaneous pressing of the function buttons 322 to 324 or simultaneous operation of the direction keys 321, in the grip devices 3L and 3R on both sides. In the double-handed operation of the present system 1, the camera function may be assigned to the simultaneous operation of different types of operation members, not limited to the simultaneous operation of the same type of operation members.

2-3-2. Case without Double-Handed Operation

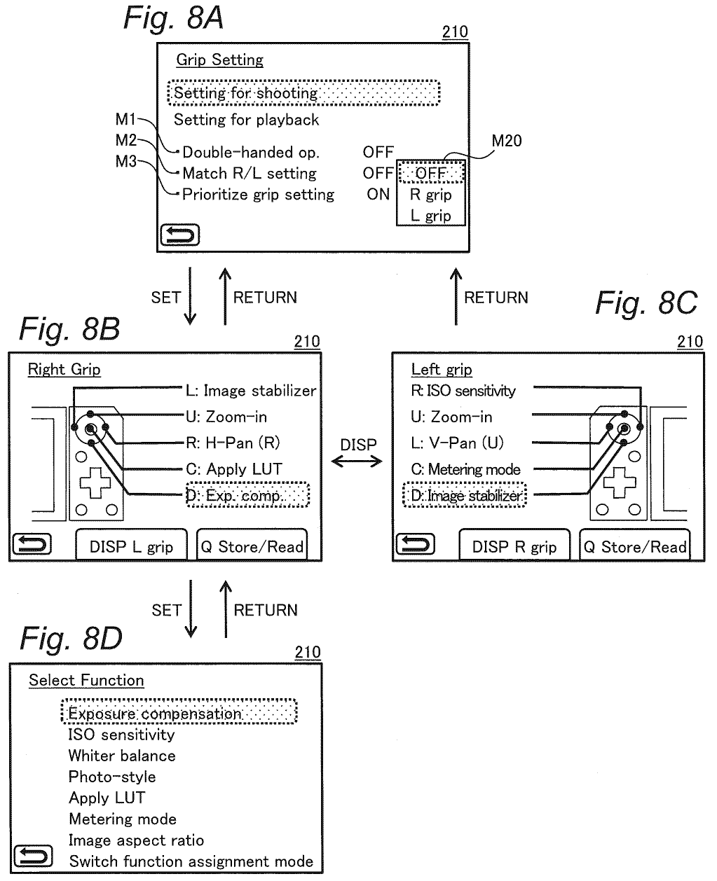

As described above, according to the present system 1, the user can assign and set desired camera functions to various simultaneous operations with both hands. In the present system 1, the camera function desired by the user can be assigned not only to the double-handed operation but also to an individual operation on the grip device 3. Such an example will be described with reference to FIGS. 8A to 8D.

FIG. 8A shows a display example different from the display example in FIG. 7B of the menu screen of the grip setting in the digital camera 10. In the present example, since the first setting item M1 is OFF, the remaining second and third setting items M2 and M3 are not displayed gray-out but displayed in a user-settable manner. In step S2 (FIG. 4A) in this case, the camera controller 180 assigns respective camera functions to individual operations of various operation members in the grip devices 3R and 3L on both sides, instead of the double-handed operation described above.

In the example in FIG. 8A, the second setting item M2 is set to OFF by the user. In this case, the camera controller 180 sets the function assignments in the grip devices 3R and 3L on both sides independently of each other (see FIGS. 8B and 8C). In the example in FIG. 8A, a list M20 including options settable to the present setting item M2 is displayed. In the present setting item M2, the user can select “right grip” or “left grip” as another option of “OFF”, for example. In the “right grip”, the function assignment of the left-side grip device 3L is determined in accordance with the function assignment setting of the right-side grip device 3R. On the other hand, in the “left grip”, the function assignment of the right-side grip device 3L is adjusted to the left-side grip device 3R.

In the camera system 1 of the present embodiment, data (setting information) indicating the setting of function assignment in the digital camera 10 can be provided not only to the digital camera 10 but also to the grip device 3 (details will be described below). In the example in FIG. 8A, the third setting item M3 is set to ON, and the setting information stored in the grip device 3 is enabled, and used in preference to the setting information stored in the camera body 11, for example. On the other hand, when the present setting item M3 is OFF, the setting stored in the camera body 11 is preferentially used. When the setting information is not stored in the grip device 3, the present setting item M3 is set to OFF and gray-out displayed.

For example, as shown in FIGS. 4B and 4C, when the setting item M1 of the double-handed operation is OFF (NO in S11), the camera controller 180 performs processing of the setting items M2 and M3 (S20 to S26). For example, when the setting item M2 of “adjust left and right settings” is “right grip” ((i) in S20), the camera controller 180 sets the setting information of the function assignment related to the user interface 32 of the right-side grip device 3R to the reading target included in step S15 (S21).

When the setting item M2 is “left grip” ((ii) in S20), the camera controller 180 sets the setting information of the function assignment of the left-side grip device 3L to the reading target (S22). When the setting item M2 is “OFF” ((iii) in S20), the camera controller 180 sets the setting information of the function assignment of the grip devices 3L and 3R on both sides to the reading target (S23).

Furthermore, when the setting item M3 of “prioritize grip setting” is ON (S24), the camera controller 180 sets the grip device 3 to a reading source included in step S15 (S25). On the other hand, when the setting item M3 is OFF (NO in S25), the camera controller 180 sets the camera body 11 to a reading source (S26). Thereafter, the camera controller 180 proceeds to step S13 in FIG. 4B, for example.

FIGS. 8B and 8C illustrate function assignment screens for the right-side and left-side grip devices 3R and 3L in the example in FIG. 8A, respectively. For example, when user operations similar to the examples in FIGS. 7A and 7B are performed from the state in FIG. 8A, the display monitor 210 transitions to the state in FIG. 8B. The display monitor 210 transitions between the states in FIGS. 8B and 8C by the operation of the DISP button 152.

In the present example, while the function assignment screen in FIG. 8B is being displayed, the camera controller 180 receives a specification operation of a camera function desired to be changed for each operation member in the right-side grip device 3R as in the example in FIG. 7B, for example. FIG. 8D illustrates a function selection screen transitioned according to the specification operation from the state in FIG. 8B. It should be noted that the function selection screen transitioned according to the specification operation from the state in FIG. 8C is the same as that in FIG. 8D.

For example, in the present example, while the function assignment screen in FIG. 8C is being displayed, the camera controller 180 receives a specification operation of a camera function desired to be changed for each operation member in the left-side grip device 3L as in the example in FIG. 8B. When the second setting item M2 in FIG. 8A is “right grip” or “left grip”, only any one of the function assignment screens in FIG. 8B and FIG. 8C may be displayed. Alternatively, the other function assignment screen may be displayed in gray-out.

For example, the camera controller 180 may perform an initial display of the function assignment screen in FIGS. 8B and 8C, according to the third setting item M3 on the grip setting screen (FIG. 8A). For example, in the example in FIG. 8A, since the present setting item M3 is ON, the camera function for each operation member initially displayed in FIGS. 8B and 8C may be displayed according to the setting information stored in the respective grip devices 3R and 3L.

According to the operation of the digital camera 10 described above, when the grip devices 3R and 3L are attached on both sides of the camera body 11 (YES in S1), it is possible to perform the double-handed operation or the function assignment other than the double-handed operation as desired according to the mode in which the user uses the present system 1.

For example, in the present system 1, if only one side of the grip devices 3L and 3R on both sides is attached to the camera body 11 (NO in S1 in FIG. 4A), the camera controller 180 sets the setting item M1 of “double-handed operation” to OFF and displays the setting item M1 in gray-out. In this case, the camera controller 180 further sets the setting item M1 of “adjust left and right settings” to OFF and displays the setting item M1 in gray-out. On the other hand, the setting item M3 of “prioritize grip setting” is displayed in a user-selectable manner, for example. In this case, the camera function can be assigned in the same manner as described above using the function assignment screen or the like in any one of FIGS. 8B and 8C according to the attached grip device 3.

In the above description, the camera body 11 and the grip device 3 have been exemplified as the reading source of the setting information of the function assignment. The present system 1 is not limited thereto, and for example, setting information of function assignment may be stored in a cloud server and used as a reading source.

### 2-4. Storage/Reading of Grip Settings

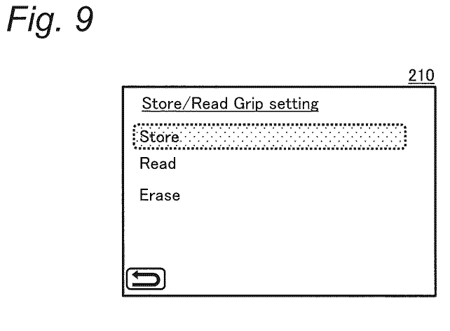

In the present system 1, the setting information of the function assignment as described above can be stored, or the stored setting information can be read and used. FIG. 9 illustrates a screen for storage/reading of grip settings in the present system 1.

For example, when the user operates the Q button 153 on the function assignment screen in FIGS. 7B, 8B, 8C, and the like, the camera controller 180 causes the display monitor 210 to transition to the screen in FIG. 9. The present screen includes selection items such as “store”, “read”, and “erase”.

When “store” in FIG. 9 is selected by a user operation, the camera controller 180 stores, setting information corresponding to the immediately preceding function assignment screen, for example. For example, as a storage destination of the setting information, any one of the memory cards 200 for each card slot 190, any one of the attached grip devices 3, or the like can be selected. For example, in the memory card 200 or the like, the camera controller 180 associates the setting information of the function assignment with the contents or the like of the setting items M1 and M2 on the grip setting screen, appropriately assigns a file name, and stores the setting information. The memory card 200 or the like may store setting information of a plurality of files regardless of the model of the digital camera 10.

When “read” in FIG. 9 is selected by a user operation, the camera controller 180 reads the stored setting information of the function assignment and displays the read setting information on the function assignment screen, for example. For example, as a reading source of the setting information, any one of the memory cards 200 for each card slot 190, any one of the attached grip devices 3, or the like can be selected. As the setting information of the reading target, a preset for shooting a moving image or a still image, or for right-handed, left-handed, or the like may be provided.

By reading such setting information, the user can use the function assignment of the stored setting information by adopting the function assignment, or modifying the function assignment from its stored content. The storage destination and the reading source of the setting information of the function assignment are not limited to the above, and for example, an external storage device such as an external SSD or an HDD, a cloud server, or the like may be selected.

When “erase” in FIG. 9 is selected by a user operation, the camera controller 180 receives an operation of selecting setting information that the user desires to erase, and erases the user-selected setting information from the storage source.

### 2-4-1. Storage of Setting Information in Grip Device

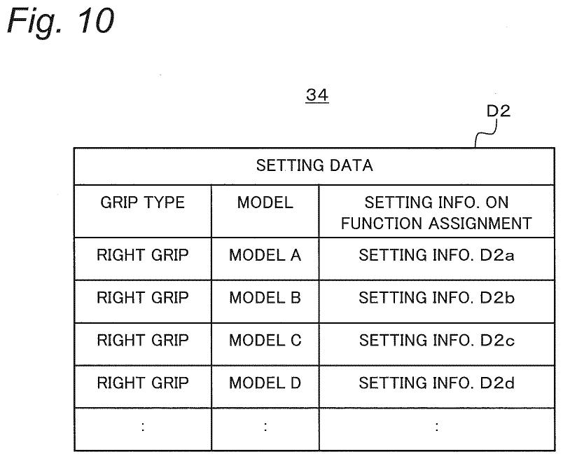

In the camera system 1 of the present embodiment, a data structure of setting information stored in the grip device 3 is illustrated in FIG. 10.

For example, as shown in FIG. 10, the grip device 3 of the present embodiment stores setting data D2 for managing setting information D2a to D2d of each function assignment for each of the models A to D of the camera body 11 in the memory 34. For example, the grip controller 33 specifies the model of the attached camera body 11 by data communication with the camera controller 180 through the mount 31, and transmits setting information of the model specified in the setting data D2 to the camera controller 180 to set.

The setting as described above can be performed on a timely basis according to the information received from the camera body 11. When an instruction to store or erase the setting information is given from the camera body 11, the grip controller 33 rewrites the setting information of the corresponding model in the setting data D2 in the memory 34. An advantage of providing the grip device 3 with the setting data D2 in this manner will be described below.

For example, due to a model change of the camera body 11, a camera function that is not included in the old model may be added to the new model, or a function included in the old model may be deleted from the new model. In addition, a difference happens in functions installed by the model depending on the difference between an entry model and a high-end model or the difference between a model focusing on a still image and a model focusing on a moving image. Therefore, the grip device 3 of the present embodiment manages the setting data D2 of the function assignment by the model. Accordingly, it is possible to actively set the assignment of the camera functions according to the model of the attached camera body 11 from the side of the grip device 3.

According to such a grip device 3 of the present embodiment, when a plurality of users shares the same digital camera 10 (the camera body 11 thereof), the grip device 3 is easily used in a use case where each user possesses the grip device 3 for himself/herself, for example. Each user can automatically obtain a setting of function assignment suitable for himself/herself by attaching his/her own grip device 3 to the shared camera body 11. At this time, even if there are a plurality of shared camera bodies 11 or a plurality of models, the user can obtain the automatic setting as described above by using a grip device 3 of his/her own.

The grip device 3 of the present embodiment is also useful when one user uses (the camera bodies 11 of) a plurality of models of digital cameras. Even in this case, by connecting the user's own grip device 3 to each camera body 11 by the user, the function assignment suitable for the model of the connected camera body 11 is automatically set by the grip device 3. In this way, the user can easily use the present system 1. Even when one user uses a plurality of grip devices 3 or when a plurality of users share a plurality of digital cameras 10 or a plurality of models of digital cameras 10, the present system 1 can be easily used using the setting data stored in the grip device 3 in the same manner as described above.

For example, in the function assignment setting processing (S2 or S3 in FIG. 4A) in the present system 1, as shown in FIG. 8A, turning the setting item M3 of “prioritize grip setting” ON allows the user to use the setting information D2a to D2d stored in the grip device 3 for the digital camera 10. Furthermore, by causing the camera body 11 to read the setting information D2a to D2d stored in the grip device 3, the user can also store the setting information D2a to D2d in the memory card 200 or the like, for example (see FIG. 9).

In the above description, an operation example in which the setting information of the function assignment in the case of the double-handed operation is not stored in the grip device 3 has been described. The present system 1 is not particularly limited thereto, and setting information of the simultaneous operation of both hands may be storable in the grip device 3. For example, by determining which of the settings of the grip devices 3R and 3L on both sides is preferentially used, the camera controller 180 may adopt the setting information when the setting information of the double-handed operation is stored in the preferential grip device 3. In this case, the setting data stored in the grip device 3 may include information on setting items such as double-handed operation in addition to the data structure in the example in FIG. 10, for example.

### 3. Review

As described above, in the present embodiment, each of the digital camera 10 and the camera body 11 is an example of an imaging apparatus that receives an operation by the user in the grip device 3 as an example of at least one input device. The imaging apparatus includes a mount 2 as an example of a connector and a camera controller 180 as an example of a controller. The mount 2 is connected to the grip device 3 so as to input signals indicating operations of various operation members of a user interface 32 provided in the grip device 3. The camera controller 180 controls the execution of a function assigned in advance to the operation of the operation member in the user interfaces 150 and 32 among a plurality of functions (camera functions) including a function related to image shooting by the imaging apparatus according to the input signal. The connector is connected to the grip device 3 in a plurality of modes in which the user operates the imaging apparatus using the grip device 3, and the camera controller 180 changes the assignment of the plurality of functions to the operation member according to the mode of use of the grip device 3.

According to the above imaging apparatus, by changing the assignment of the camera functions according to various modes of use of the grip device 3 by the user, it is possible to easily operate the imaging apparatus by various operation members including the operation member of the user interface 32 in the grip device 3 along the user's preference.

In the present embodiment, the camera controller 180 detects a state in which the grip device 3 is connected to the connector as a mode of use of the grip device 3 (S1). Accordingly, it is possible to easily operate the imaging apparatus by various operation members along the user's preference according to the mode of the connected grip device 3.

In the present embodiment, the at least one grip device 3 includes grip devices 3L and 3R as examples of the first and second input devices. The connector includes a mount 2L as an example of a first mount for attaching the grip device 3L to one side surface of both side surfaces of the imaging apparatus, and a mount 2R as an example of a second mount for attaching the grip device 3R to the other side surface. Accordingly, it is possible to easily operate the imaging apparatus with various operation members according to a mode in which the grip device 3 is attached to both sides or one side of the imaging apparatus in each of the mounts 2L and 2R.

In the imaging apparatus of the present embodiment, the plurality of modes include a mode in which the user uses the grip device 3 with both hands and a mode in which the user uses the grip device 3 with one hand. According to such a mode of use of grip with both hands or one hand, the present system 1 can easily operate the imaging apparatus with various operation members.

The imaging apparatus according to the present embodiment further includes a display monitor 210 that displays various setting screens and a user interface 150 that receives an operation thereof as an example of a setting interface that assigns a plurality of functions to a plurality of operation members including an operation member of the grip device 3 based on a user's instruction. Accordingly, the user can specify desired function assignment, and the operation of the imaging apparatus by various operation members can be easily performed along the user's preference.

In the present embodiment, when a double-handed operation (see FIG. 5) as an example of a first user operation of simultaneously operating the joystick 320 as an example of two operation members is input (YES in S5 and S6), the camera controller 180 executes a first function among a plurality of functions (S7). On the other hand, when the first user operation is not input to the two operation members, the camera controller 180 does not execute the first function (NO in S6). Accordingly, the camera function can be executed according to the simultaneous operation by the two operation members, and the operation of the imaging apparatus can be easily performed according to the user's preference.

In the present embodiment, when a second user operation is input in which two operation members are simultaneously operated in a way different from that of the first user operation, the camera controller 180 executes a second function different from the first function among the plurality of functions. For example, the two types of double-handed operation in FIG. 5 are examples of the first and second user operations, and the corresponding camera functions are examples of the first and second functions. According to the function assignment of the double-handed operation, the user can easily use a plurality of camera functions and easily operate the imaging apparatus.

In the present embodiment, a camera system 1 as an example of an imaging system includes at least one grip device 3 and an imaging apparatus (10, 11). At least one of the imaging apparatus (10, 11) and the grip device 3 includes a memory that stores setting information indicating the assignment of a plurality of functions to the operation member. According to such a camera system 1, the operation of the imaging apparatus by various operation members can be easily performed along the user's preference.

In the present system 1, the camera body 11 has a predetermined outer shape such as a box shape. The grip device 3 has a shape more suitable for being gripped by a user's hand than the outer shape of the camera body 11. With the grip device 3, it is possible to provide the camera system 1 which is easier for the user to grip than the camera body 11.

The imaging apparatus according to the present embodiment includes a connector connected to the grip device 3 so as to input a signal indicating an operation of an operation member provided in the grip device 3, and a camera controller 180 that controls execution of a function assigned in advance to the operation of the operation member among a plurality of functions including a function related to image shooting by the imaging apparatus according to the input signal. When a first user operation of simultaneously operating two operation members including an operation member of the grip device 3 is input, the camera controller 180 executes a first function among the plurality of functions, and when a second user operation of simultaneously operating the two operation members in a way different from the first user operation is input, the camera controller 180 executes a second function different from the first function among the plurality of functions. Also with such an imaging apparatus, the operation of the imaging apparatus by various operation members can be easily performed along the user's preference.

In the present embodiment, the grip device 3 is an example of an input device that receives an operation by a user for the imaging apparatus. The grip device 3 includes various operation members in the user interface 32, a mount 31 as an example of a connector connected to the imaging apparatus so as to output a signal indicating an operation of the operation member to the imaging apparatus, a memory 34 that stores setting information indicating assignment of a plurality of functions in the imaging apparatus to the operation member, and a grip controller 33 as an example of a controller that sets the setting information in the imaging apparatus through the connector. According to such an input device, by utilizing the setting information provided in the input device, the operation of the imaging apparatus by various operation members can be easily performed along the user's preference.

In the grip device 3 of the present embodiment, the memory 34 stores, by the type of imaging apparatus, the setting information D2a to D2d. The grip controller 33 sets setting information corresponding to the type of the connected imaging apparatus in the imaging apparatus based on the imaging apparatus connected to the connector. Accordingly by using the setting information by the type such as the model of the imaging apparatus, the operation of the imaging apparatus by the operation member can be easily performed along the user's preference in various modes of use of the imaging apparatus, for example.

### Other Embodiments

As described above, the first embodiment has been described as an exemplification of the technique disclosed in the present application. However, the technique in the present disclosure is not limited thereto, and can also be applied to embodiments in which changes, substitutions, additions, omissions, and the like are made as appropriate. In addition, it is also possible to combine each component described in the above embodiment to form a new embodiment. Thus, in the following, other embodiments will be exemplified.

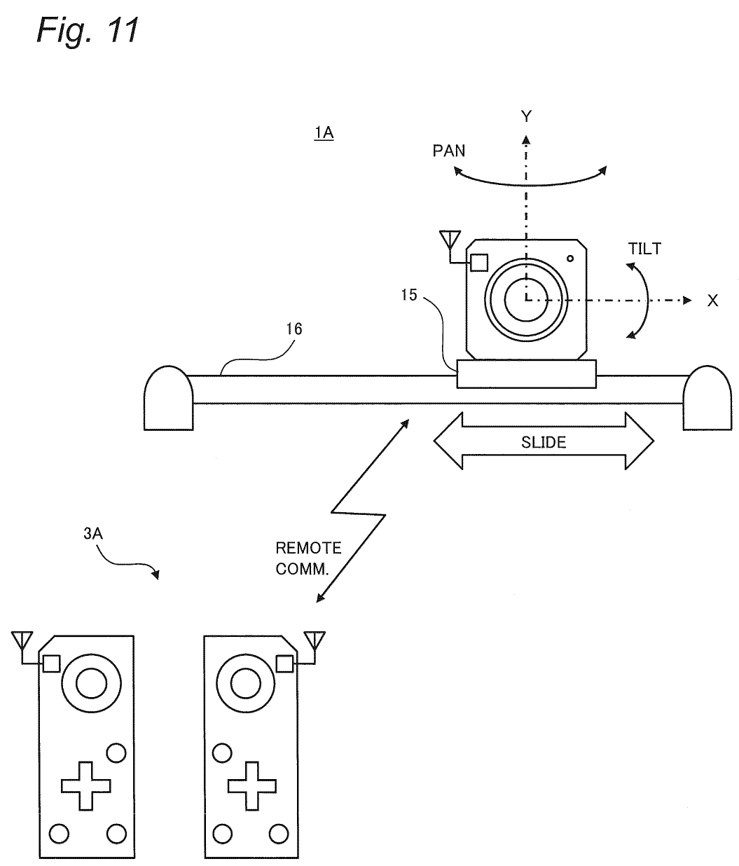

In the first embodiment, the camera system 1 in which the grip device 3 is attached to the digital camera 10 has been described. In the present embodiment, the grip device 3 does not need to be attached to the digital camera 10. Such a modification will be described with reference to FIG. 11.

FIG. 11 illustrates a camera system 1A according to a modification. In the camera system 1A of the present embodiment, the grip device 3A may remotely control the digital camera 10. For example, in a configuration similar to the configuration of the first embodiment, the grip device 3A of the present embodiment may include an interface circuit that is communicably connected to the digital camera 10 or the like by wireless communication (or cable communication) as an example of a connector instead of the mount 31, for example.

In the example in FIG. 11, the camera system 1A may include a camera platform 15 and a slider 16 that support the digital camera 10, in addition to the digital camera 10 and the grip device 3A. For example, in the digital camera 10 of the present embodiment, the camera controller 180 has the function of controlling the drive of the camera platform 15 and the slider 16. In such a camera system 1A various functions of performing pan drive (rotation around the X axis) and tilt drive (rotation around the Y axis) of the camera platform 15 or slide drive of the slider 16 may be assigned to the operation member of the grip device 3A, for example. For example, the user can implement a shooting technique such as operating the slide drive of the slider 16 on the other joystick 320 while operating the pan drive and the like of the camera platform 15 on one joystick 320 of the grip devices 3A for both hands.

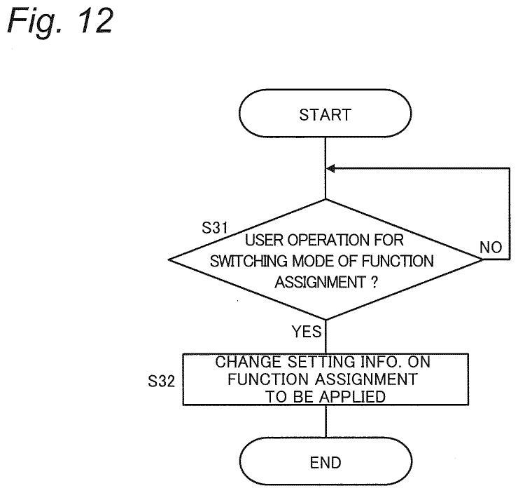

The camera system 1 according to the present embodiment may have a mode switching function of performing mode switching between function assignment of the double-handed operation and function assignment of not the double-handed operation in a state where the grip devices 3R and 3L are attached to both sides of the digital camera 10, for example. Such an example will be described with reference to FIG. 12.

For example, the flow illustrated in FIG. 12 starts in a state where such a function assignment mode switching function is assigned to the function button 322 or the like and setting information of function assignment of each mode is stored in the digital camera 10. In this state, when the user operates the function button 322 while using the present system 1 (YES in S31), the camera controller 180 changes the setting information to be applied among the setting information stored in advance (S32). Accordingly, when the user operates the digital camera 10 with both hands, the user can switch whether to be the mode of double-handed operation on a timely basis and can easily use the present system 1.

As described above, the imaging apparatus according to the present embodiment may have a plurality of setting modes in which the assignment of the plurality of functions to the operation member is different from each other, and the camera controller 180 may change the assignment of the plurality of functions according to the selection of the user in the plurality of setting modes. This also makes it easy to operate the imaging apparatus with various operation members along the user's preference.

Tn the present embodiment, the grip device 3 may be provided in various sizes. For example, a small grip device 3 can be easily used by a user having a relatively small hand, and the device configuration can be reduced in weight and size. A large grip device 3 can be easily used by a user having a relatively large hand, and can increase the capacity of the battery 30.

In the above embodiment, the double-handed operation of two operation members in the grip device 3 has been described. In the present embodiment, the operation member to be operated simultaneously is not necessarily limited to the operation member of the grip device 3, and may include the user interface 150 of the digital camera 10. For example, the camera function may be assigned to double-handed operation of the operation member provided in the camera body 11 and the operation member of the grip device 3. For example, the camera function may be assigned to such a plurality of operation members as to be operated with a plurality of fingers of the same hand, not limited to such two operation members as to be operated with both hands.

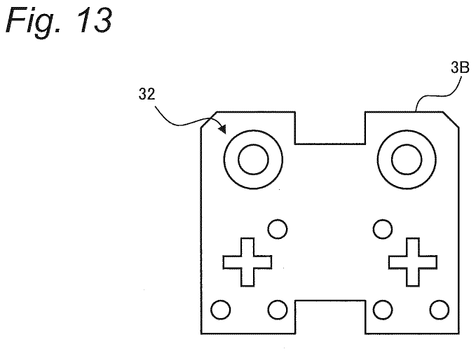

In the above embodiment, the grip device 3 is exemplified as an example of the input device. The input device of the present embodiment is not necessarily limited to the grip device 3 and may be various input devices that receive a user operation for operating the imaging apparatus. An example of such a modification will be described with reference to FIG. 13.

FIG. 13 illustrates an input device 3B according to a modification. In the imaging system of the present embodiment, as shown in FIG. 13, an input device 1B having a shape suitable for the user to grip with both hands may be used, for example. In the imaging apparatus of the present embodiment, the function assignment can be set also for the various user interfaces 32 in the input device 3B of the modification as in the above embodiment.

In the above embodiments, an example of the configuration of the digital camera 10 has been described as an example of the imaging apparatus. In the present embodiment, the digital camera 10 is not particularly limited to the above configuration, and may have various configurations. For example, the digital camera 10 does not need to be an interchangeable lens type, and may be an integrated lens type. The digital camera 10 does not need to be particularly a box camera. The imaging apparatus of the present embodiment may constitute a head-mounted display, a smart glass, or the like.

### Summary of Aspects

Hereinafter, various aspects according to the present disclosure will be appended.

A first aspect according to the present disclosure is an imaging apparatus for receiving an operation by a user via at least one input device. The imaging apparatus includes: a connector connectable with the input device to input a signal indicating an operation of an operation member provided in the input device; and a controller that controls execution of an assigned function for the operation member according to the input signal, the assigned function being in advance assigned to the operation of the operation member among a plurality of functions including a function for image shooting with the imaging apparatus. The connector is connectable with the input device in each of a plurality of modes each allowing the user to operate the imaging apparatus with the input device The controller changes assignment of the plurality of functions to the operation member, according to a using mode for the input device in the plurality of modes.

According to a second aspect, in the imaging apparatus according to the first aspect, the controller detects a state in which the input device is connected to the connector, as the using mode for the input device.

According to a third aspect, in the imaging apparatus according to the first or second aspect, the at least one input device includes a first input device and a second input device. The connector includes: a first mount that attaches the first input device to one side of both sides of the imaging apparatus; and a second mount that attaches the second input device to another side.

According to a fourth aspect, in the imaging apparatus according to any one of the first to third aspects, the plurality of modes include a mode allowing the user to use the input device with both hands, and another mode allowing the user to use the input device with one hand.

According to a fourth aspect, the imaging apparatus according to any one of the first to fourth aspects further includes a setting interface that assigns the plurality of functions to a plurality of operation members including the operation member of the input device, based on an instruction of the user.

According to a sixth aspect, in the imaging apparatus according to any one of the first to fifth aspects, when a first user operation is input, the controller performs a first function among the plurality of functions, the first user operation simultaneously operating two operation members. When the first user operation is not input to the two operation members, the controller does not perform the first function.

According to a seventh aspect, in the imaging apparatus according to the sixth aspect, when a second user operation is input, the controller performs a second function different from the first function among the plurality of functions, the second user operation operating the two operation members simultaneously in a way different from the first user operation.

According to an eighth aspect, an imaging system includes: the at least one input device; and the imaging apparatus the imaging apparatus according to any one of the first to seventh aspects. At least one of the imaging apparatus or the input device comprises a memory that stores setting information indicating the assignment of the plurality of functions to the operation member.

According to a ninth aspect, in the imaging system according to the eighth aspect, the imaging apparatus has a predetermined outer shape. The input device has a shape more suitable for the user to grip by a hand of the user than the outer shape of the imaging apparatus.

According to a tenth aspect, an imaging apparatus for receiving an operation by a user in at least one input device, the imaging apparatus includes: a connector connected to the input device to input a signal indicating an operation of an operation member provided in the input device; and a controller that controls execution of an assigned function for the operation member, according to the input signal, the assigned function being in advance assigned to the operation of the operation member among a plurality of functions including a function for image shooting with the imaging apparatus. When a first user operation is input, the controller performs a first function among the plurality of functions, the first user operation operating simultaneously two operation members including an operation member of the input device. When a second user operation is input, the controller performs a second function different from the first function among the plurality of functions, the second user operation operating the two operation members simultaneously in a way different from the first user operation.

According to an eleventh aspect, an input device for receiving an operation by a user for an imaging apparatus, the input device includes: an operation member; a connector connectable to the imaging apparatus to output a signal indicating an operation of the operation member to the imaging apparatus; a memory that stores setting information indicating assignment of a plurality of functions in the imaging apparatus to the operation member, and a controller that sets the setting information in the imaging apparatus via the connector.

According to a twelfth aspect, in the input device according to the eleventh aspect, the memory stores setting information by a type of imaging apparatus. Based on the imaging apparatus connected to the connector, the controller sets the setting information corresponding to the type of the connected imaging apparatus thereto.

As described above, the embodiments are described as the exemplification of the technique in the present disclosure. To that end, the accompanying drawings and the detailed description are provided.

Therefore, among the components described in the accompanying drawings and the detailed description, not only the component essential for solving the problem, but also the component not essential for solving the problem may be included in order to exemplify the above technique. Therefore, it should not be recognized that these non-essential components are essential immediately because these non-essential components are described in the accompanying drawings and the detailed description.

In addition, since the above embodiment is for illustrating the technique in the present disclosure, various changes, substitutions, additions, omissions, and the like can be made within the scope of the claims or the equivalent thereof.

### INDUSTRIAL APPLICABILITY

The present disclosure can be applied to an imaging apparatus and an input device including various operation members, and can be applied to, for example, a box camera and a grip device thereof.

1. An imaging apparatus for receiving an operation by a user via at least one input device, the imaging apparatus comprising:
a connector connectable with the input device to input a signal indicating an operation of an operation member provided in the input device; and
a controller that controls execution of an assigned function for the operation member according to the input signal, the assigned function being in advance assigned to the operation of the operation member among a plurality of functions including a function for image shooting with the imaging apparatus, wherein
the connector is connectable with the input device in each of a plurality of modes each allowing the user to operate the imaging apparatus with the input device, and
the controller changes assignment of the plurality of functions to the operation member, according to a using mode for the input device in the plurality of modes.

2. The imaging apparatus according to claim 1, wherein the controller detects a state in which the input device is connected to the connector, as the using mode for the input device.

3. The imaging apparatus according to claim 1, wherein
the at least one input device includes a first input device and a second input device, and
the connector includes: a first mount that attaches the first input device to one side of both sides of the imaging apparatus; and a second mount that attaches the second input device to another side.

4. The imaging apparatus according to claim 1, wherein the plurality of modes include a mode allowing the user to use the input device with both hands, and another mode allowing the user to use the input device with one hand.

5. The imaging apparatus according to claim 1, further comprising a setting interface that assigns the plurality of functions to a plurality of operation members including the operation member of the input device, based on an instruction of the user.

6. The imaging apparatus according to claim 1, wherein
when a first user operation is input, the controller performs a first function among the plurality of functions, the first user operation simultaneously operating two operation members, and
when the first user operation is not input to the two operation members, the controller does not perform the first function.

7. The imaging apparatus according to claim 6, wherein
when a second user operation is input, the controller performs a second function different from the first function among the plurality of functions, the second user operation operating the two operation members simultaneously in a way different from the first user operation.

8. An imaging system comprising:
the at least one input device; and
the imaging apparatus according to claim 1, wherein
at least one of the imaging apparatus or the input device comprises a memory that stores setting information indicating the assignment of the plurality of functions to the operation member.

9. The imaging system according to claim 8, wherein
the imaging apparatus has a predetermined outer shape, and
the input device has a shape more suitable for the user to grip by a hand of the user than the outer shape of the imaging apparatus.

10. An imaging apparatus for receiving an operation by a user in at least one input device, the imaging apparatus comprising:
a connector connected to the input device to input a signal indicating an operation of an operation member provided in the input device; and
a controller that controls execution of an assigned function for the operation member, according to the input signal, the assigned function being in advance assigned to the operation of the operation member among a plurality of functions including a function for image shooting with the imaging apparatus, wherein
when a first user operation is input, the controller performs a first function among the plurality of functions, the first user operation operating simultaneously two operation members including an operation member of the input device, and
when a second user operation is input, the controller performs a second function different from the first function among the plurality of functions, the second user operation operating the two operation members simultaneously in a way different from the first user operation.

11. An input device for receiving an operation by a user for an imaging apparatus, the input device comprising:
an operation member;
a connector connectable to the imaging apparatus to output a signal indicating an operation of the operation member to the imaging apparatus;
a memory that stores setting information indicating assignment of a plurality of functions in the imaging apparatus to the operation member, and
a controller that sets the setting information in the imaging apparatus via the connector.

12. The input device according to claim 11, wherein
the memory stores setting information by a type of imaging apparatus, and
based on the imaging apparatus connected to the connector, the controller sets the setting information corresponding to the type of the connected imaging apparatus thereto.
